(19) United States
(12) Patent Application Publication
(10) Pub. No.: US 2013/0254541 A1
(43) Pub. Date: Sep. 26, 2013

(54) ACCESS CONTROL SYSTEM AND A USER TERMINAL

(71) Applicants: Shinji Yamanaka, Tokyo (JP); Yuichi Komano, Kanagawa-ken (JP); Satoshi Ito, Tokyo (JP)

(72) Inventors: Shinji Yamanaka, Tokyo (JP); Yuichi Komano, Kanagawa-ken (JP); Satoshi Ito, Tokyo (JP)

(73) Assignee: KABUSHIKI KAISHA TOSHIBA, Tokyo (JP)

(21) Appl. No.: 13/596,362

(22) Filed: Aug. 28, 2012

(30) Foreign Application Priority Data
Mar. 22, 2012 (JP) 2012-066368

(51) Int. Cl. H04L 9/32

(52) U.S. Cl. 713/168

(57) ABSTRACT

In a user terminal, a public key, a master key and a public parameter are generated. An ID including an identifier, an issue date and a validity period of a secret key for service is generated. The secret key is generated based on the master key and the ID. The ID and the secret key are transmitted to a service providing server. The public key and the public parameter are transmitted to a data storage device. In the service providing server, signature data is generated based on the ID and the secret key. A data request, the signature data and the ID are transmitted to the data storage device. In the data storage device, the data request is verified based on the signature data, the public key and the public parameter. When the data request is verified, measurement data of a target device is transmitted to the service providing server.

### CROSS-REFERENCE TO RELATED APPLICATION

This application is based upon and claims the benefit of priority from Japanese Patent Application No. 2012-066368, filed on Mar. 22, 2012; the entire contents of which are incorporated herein by reference.

### FIELD

Embodiments described herein relate generally to an access control system and a user terminal.

### BACKGROUND

In addition to a conventional power generation such as a nuclear power generation or a steam power generation, when a renewable energy such as sunlight or a force of wind is utilized together, in order to stabilize a quality of the power, a smart grid is composed. As to the smart grid, a smart meter (Hereinafter, it is called “SM”) to sum a power consumption and a home server to control an electric product are installed into each home or each office. The SM communicates a meter data management system (Hereinafter, it is called “MDMS”) via an electronic power network. The MDMS receives (measures) the power consumption at a predetermined interval from the SM of each home or each office, and stores it into a storage server. Furthermore, as to another (infra) service, some measurement data are stored and utilized. On the other hand, in order to protect the measurement data, encoding of the measurement data is investigated.

### BRIEF DESCRIPTION OF THE DRAWINGS

FIG. 1 is a block diagram of an access control system according to a first embodiment.

FIG. 2 is a block diagram of a user terminal in FIG. 1.

FIG. 3 is a block diagram of a data storage device in FIG. 1.

FIG. 4 is a block diagram of a service providing server in FIG. 1.

FIG. 5 is a flow chart of setup processing according to the first embodiment.

FIG. 6 is a flow chart of service registration processing according to the first embodiment.

FIG. 7 is a flow chart of data request/acquisition processing according to the first embodiment.

FIG. 8 is a flow chart of secret key-update processing according to the first embodiment.

FIG. 9 is a flow chart of service change processing according to the first embodiment.

FIG. 10 is a block diagram of an access control system according to a second embodiment.

FIG. 11 is a block diagram of a user terminal in FIG. 2.

FIG. 12 is a block diagram of a data storage device in FIG. 2.

FIG. 13 is a block diagram of a service providing server in FIG. 2.

FIG. 14 is a flow chart of setup processing according to the second embodiment.

FIG. 15 is a flow chart of service registration processing according to the second embodiment.

FIG. 16 is a flow chart of data request/acquisition processing according to the second embodiment.

FIG. 17 is a flow chart of secret key-update processing according to the second embodiment.

FIG. 18 is a flow chart of service change processing according to the second embodiment.

FIG. 19 is a flow chart of resetup processing according to the second embodiment.

### DETAILED DESCRIPTION

According to one embodiment, an access control system includes a user terminal, a data storage unit and a service providing server mutually connected via a network. The user terminal includes a key set generation unit, a key set storage, an ID generation unit, a first ID storage, a secret key generation unit, and a first transmit unit. The key set generation unit is configured to generate a key set including a public key, a master key and a public parameter as a parameter opened, by using an ID-based signature scheme based on seed information. The key set storage stores the key set. The ID generation unit is configured to generate an ID including an identifier of a service, an issue date and a validity period of a secret key corresponding to a service provided by the service providing server. The first ID storage stores the ID. The secret key generation unit is configured to generate the secret key based on the master key and the ID. The first transmit unit is configured to transmit the ID and the secret key to the service providing server, and to transmit the public key, the public parameter and a revocated ID to the data storage device. The service providing server includes a signature data generation unit, a second ID storage, a secret key storage, a data request generation unit, and a third transmit unit. The signature data generation unit is configured to generate signature data based on the ID and the secret key. The second ID storage stores the ID. The secret key storage stores the secret key. The data request generation unit is configured to generate a data request command including a data request, the signature data and the ID. The third transmit unit is configured to transmit the data request command to the data storage device. The data storage device includes a first data storage, a revocated ID list storage, a public key storage, a revocated ID list storage controller, a signature verification unit, and a second transmit unit. The first data storage stores measurement data measured from a measurement target device. The revocated ID list storage stores the revocated ID. The public key storage stores the public key and the public parameter. The revocated ID list storage controller is configured to decide whether the ID is same as the revocated ID. The signature verification unit is configured to verify the data request based on the signature data, the public key and the public parameter. The second transmit unit is configured to transmit the measurement data to the service providing server, when the ID is not same as the revocated ID and when authenticity of the data request is verified. In the user terminal, the ID generation unit generates a new ID including an identifier of a new service, an issue date and a validity period of a new secret key corresponding to the new service, the secret key generation unit generates the new secret key based on the master key and the new ID, and the first transmit unit transmits the new ID and the new secret key to the service providing server. In the service providing server, the second ID storage stores the new ID, and the secret key storage stores the new secret key.

Various embodiments will be described hereinafter with reference to the accompanying drawings.

### The First Embodiment

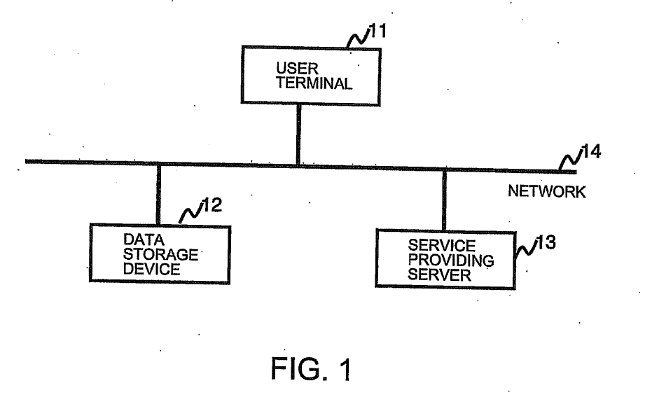

FIG. 1 is a block diagram of an access control system 1 according to the first embodiment. As shown in FIG. 1, in the access control system 1, a user terminal 11, a data storage device 12 and a service providing server 13, are connected via a communication network 14.

Moreover, in order to simplify Figure, as the user terminal 11, the data storage device 12 and the service providing server 13, respective one units are only shown in FIG. 1. However, a plurality of user terminals 11, a plurality of data storage devices 12 and a plurality of service providing servers 13, can be connected with the access control system 1.

The network 14 is, for example, a LAN (Local Area Network), an Intranet, an Ethernet (registered trademark), or the Internet.

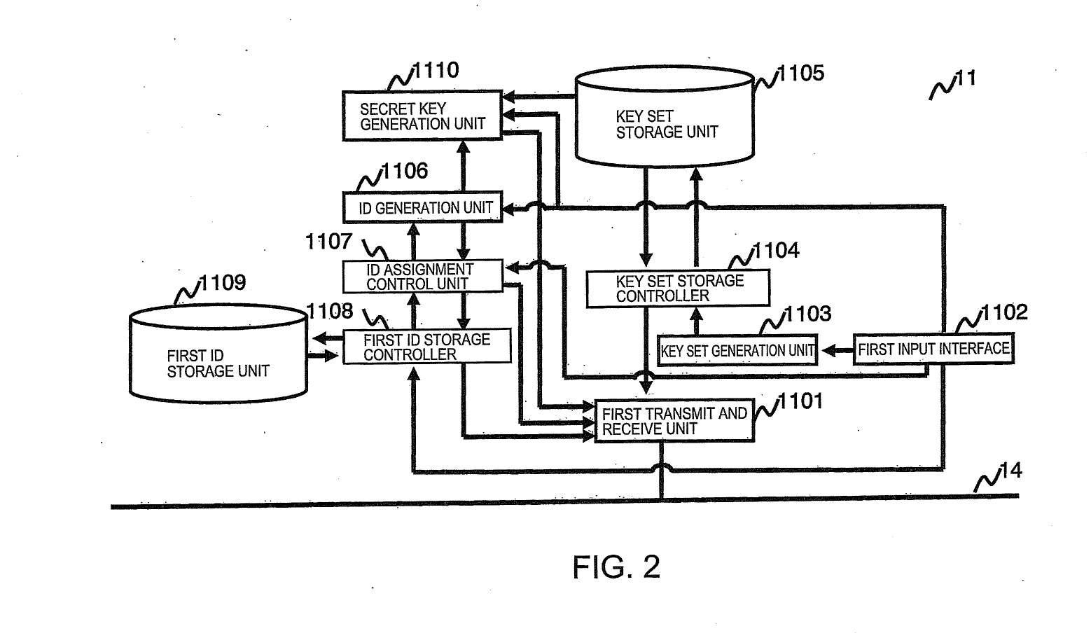

FIG. 2 is a block diagram of the user terminal 11 according to the first embodiment.

The user terminal 11 includes a first transmit and receive unit 1101, a first input interface 1102, a key set generation unit 1103, a key set storage controller 1104, a key set storage unit 1105, an ID generation unit 1106, an ID assignment control unit 1107, a first ID storage controller 1108, a first ID storage unit 1109, and a secret key generation unit 1110.

The first transmit and receive unit 1101 transmits/receives data with other devices except for the user terminal 11. For example, the first transmit and receive unit 1101 transmits data to or receives data from the data storage device 12 and the service providing server 13.

The first transmit and receive unit 1101 transmits or receives data for mutual authentication with the data storage device 12 and the service providing server 13.

The first transmit and receive unit 1101 transmits a public key P_pub and params included in a key set generated by the key set generation unit 1103.

The first transmit and receive unit 1101 transmits an ID, a secret key d_ID, and params to the service providing server 13.

Furthermore, the first transmit and receive unit 1101 transmits a new secret key d_ID′ generated at secret key-update processing.

The first transmit and receive unit 1101 transmits a revocated ID to the data storage device 12.

The first input interface 1102 accepts a request from a user and so on.

The key set generation unit 1103 accepts a request from the first input interface 1102, and creates a key set (used by the access control system 1) based on seed information.

The seed information is original information for the key set, and includes a parameter size.

The key set is a plurality of values created by ID-based signature scheme, for example, (P_pub, s, params). Here, “P_pub” is a public key used for verification of the signature. “s” is a master key used for generation of the secret key (necessary for generation of a signature). Furthermore, “params” is a public parameter as a parameter opened, which is used for generation of the secret key and generation/verification of the signature. The master key is secret information and should be suitably protected in order not to leak out from the user terminal 11. The protection method thereof is not explained. Furthermore, the key set is sent to the key set storage controller 1104.

The key set storage controller 1104 accepts the key set from the key set generation unit 1103, and writes the key set into the key set storage unit 1105.

The ID generation unit 1106 generates an ID by ID-based signature scheme. The ID is information paired with the secret key. For example, the ID includes at least “a” and “b” explained afterwards, and may further include “c”. Briefly, the ID is defined as “ID=(a,b)” or “ID=(a,b,c)”, and issued in correspondence with service provision explained afterwards.

Here, “a” is an identifier of a service providing company to issue the secret key, which is inputted from outside of the user terminal 11. Except for input by the user, “a” may be inputted by connecting another device with the user terminal 11. For example, a character string, random information (such as a number), or a combination thereof, may be inputted. The random information may be information based on a random number generated in the user terminal 11.

Furthermore, “b” is an issue date and a validity period of the secret key. The validity period is acquired from a clock (not shown in FIG. 1).

Furthermore, “c” is a parameter peculiar to each service (such as power distribution service) which issues the secret key, for example, a cycle to acquire data. The parameter peculiar to each service is inputted from the first input interface 1102. Except for input by the user, “c” may be inputted by connecting another device with the user terminal 11.

The ID generation unit 1106 sends the ID to the ID assignment control unit 1107 and the secret key generation unit 1110.

When the ID is same as one of (existing) IDs stored in the first ID storage unit 1109, the ID generation unit 1106 accepts a request to generate a new ID from the ID assignment control unit 1107, and generates the new ID by changing an identifier of the service providing company included in the ID.

The ID assignment control unit 1107 requests the first ID storage controller 1108 to read IDs, and confirms whether the ID (generated by the ID generation unit 1106) is same as one of IDs stored in the first ID storage unit 1109.

When the ID is not same as each of IDs, the ID assignment control unit 1107 sends the ID and a request to write into the first ID storage unit 1109, to the first ID storage controller 1108.

When the ID is same as one of IDs, the ID assignment control unit 1107 sends a request to generate a new ID by changing the identifier therein, to the ID generation unit 1106. As a result, overlap of the ID is removed.

Furthermore, based on information stored in the first ID storage unit 1109, the ID assignment control unit 1107 confirms whether a validity period of each ID (stored in the first ID storage unit 1109) has expired, via the first ID storage controller 1108.

When the validity period of at least one ID has expired, the ID assignment control unit 1107 deleted this ID from the first ID storage unit 1109.

Furthermore, when the ID assignment control unit 1107 accepts a request to revocate an ID from the first input interface 1102, the ID assignment control unit 1107 deletes this ID from the first ID storage unit 1109.

The ID assignment control unit 1107 sends this ID to the first transmit and receive unit 1101.

When the ID assignment control unit 1107 accepts a request to read an ID from the first input interface 1102, the ID assignment control unit 1107 sends the request to read this ID to the first ID storage controller 1108.

When the first ID storage controller 1108 accepts the request to write an ID from the ID storage controller 1107, the first ID storage controller 1108 writes this ID into the first ID storage unit 1109.

When the first ID storage controller 1108 accepts the request to read an ID from the ID storage controller 1107, the first ID storage controller 1108 reads this ID from the first ID storage unit 1109, and sends this ID to the first transmit and receive unit 1101.

The first ID storage unit 1109 stores IDs.

When the secret key generation unit 1110 accepts a request to generate a secret key from the first input interface 1102, the secret key generation unit 1110 generates a secret key d_ID based on a key set Kset and the ID. This secret key corresponds to each service providing company. The secret key generation unit 1110 reads the key set Kset from the key set storage unit 1105, and accepts the ID from the ID generation unit 1106.

The secret key generation unit 1110 sends the secret key d_ID to the first transmit and receive unit 1101.

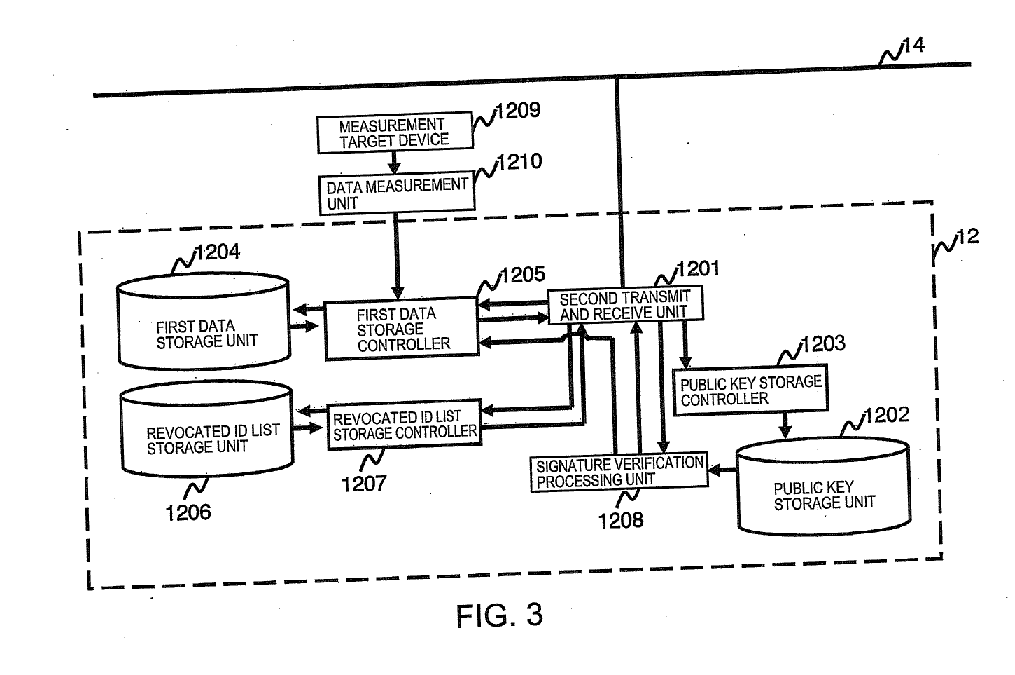

FIG. 3 is a block diagram of the data storage device 12 according to the first embodiment. The data storage device 12 includes a second transmit and receive unit 1201, a public key storage unit 1202, a public key storage controller 1203, a first data storage unit 1204, a first data storage controller 1205, a revocated ID list storage unit 1206, a revocated ID list storage controller 1207, and a signature verification processing unit 1208.

Furthermore, as peripheral equipments, a measurement target device 1209 and a data measurement unit 1210 exists. These are not always included in the data storage device 12.

The second transmit and receive unit 1201 transmits data to or receives data from other devices except for the data storage device 12. For example, the second transmit and receive unit 1201 transmits data to or receives data from the user terminal 11 and the service providing server 13.

The second transmit and receive unit 1201 receives a public key P_pub and a public parameter params from the user terminal 11.

The second transmit and receive unit 1201 transmits the public key P_pub, the public parameter params, and a request to write them, to the public key storage controller 1203.

The second transmit and receive unit 1201 receives measurement data measured by the data measurement unit 1210, and transmits the measurement data and a request to write them to the first data storage controller 1205. Here, the data measurement unit 1210 measures data of the measurement target device 1209. As the measurement data, a power consumption, a gas consumption, or a water service consumption, may be included. Another data may be included.

The second transmit and receive unit 1201 accepts a request to read measurement data (stored in the first data storage unit 1204) from the service providing server 13. When this request is received, the second transmit and receive unit 1201 reads measurement data of a request target from the first data storage unit 1204 via the first data storage controller 1205, and transmits the measurement data to the service providing server 13.

The second transmit and receive unit 1201 receives an ID to be revocated from the user terminal 11, and transmits this ID to the revocated ID list storage controller 1207.

The public key storage controller 1203 accepts the public key P_pub, the public parameter params, and a request to write them (received from the user terminal 11), and writes the public key P_pub and the public parameter params with a use start time (including the date) into the public key storage unit 1202.

The use start time is acquired from a clock included in the data storage device 12 by the public key storage controller 1203.

The public key storage unit 1202 stores the public key P_pub and the public parameter params.

The data measurement unit 1210 measures data of the measurement target device 1209, and transmits measurement data to the first data storage controller 1205. For example, the measurement data is a power consumption, a gas consumption, or a water service consumption.

The first data storage unit 1204 stores the measurement data from the data measurement unit 1210.

The first data storage controller 1205 accepts the measurement data from the data measurement unit 1210, and writes it into the first data storage unit 1204.

The first data storage controller 1205 accepts a request from the service providing server 13 via the second transmit and receive unit 1201, reads data of a request target from the first data storage unit 1204, and transmits the data to the second transmit and receive unit 1201.

When an ID to be revocated is transmitted from the user terminal 11, the revocated ID list storage controller 1207 writes this ID into the revocated ID list storage unit 1206. When data is requested from the service providing server 13, the revocated ID list storage controller 1207 confirms whether an ID (transmitted from the service providing server 13) of the data is valid by referring to IDs stored in the revocated ID list storage unit 1206. For example, if this ID is same as one of IDs stored in the revocated ID list storage unit 1206, the revocated ID list storage controller 1207 decides that this ID is revocated, and sends an error to the second transmit and receive unit 1201.

Furthermore, by checking a list of revocated IDs stored in the revocated ID list storage unit 1206, the revocated ID list storage controller 1207 deletes an ID of which validity period of a secret key has expired, from the list. For example, the revocated ID list storage controller 1207 decides whether a validity period of each secret key has expired by referring to the validity period of each secret key included in each ID. If the revocated ID list storage controller 1207 decides that the validity period of a secret key included in an ID has expired, the revocated ID list storage controller 1207 deletes this ID from the list of revocated IDs.

When an ID to be revocated is transmitted from the user terminal 11, the revocated ID list storage unit 1206 stores the ID.

When a request of data is received from the service providing server 13, IDs stored in the revocated ID list storage unit 1206 are used for deciding whether an ID of the requested data is valid.

When a request of data is received from the service providing server 13, the signature verification processing unit 1208 verifies a signature sig (transmitted from the server 13) of a data request M by using the public key P_pub and the public parameter params stored in the public key storage unit 1202.

For example, the signature verification processing unit 1208 receives a data request M, a signature sig thereof, and an ID from the service providing server 13 via the second transmit and receive unit 1201.

The signature verification processing unit 1208 reads the public key P_pub and the public parameter params from the public key storage unit 1202.

The signature verification processing unit 1208 verifies the signature sig by ID-based signature scheme, based on the data request M, the ID, the public key P_pub, and the public parameter params.

When the verification result is correct, the signature verification processing unit 1208 sends a data request to the first data storage controller 1205.

When the verification result is incorrect, the signature verification processing unit 1208 sends an error to the second transmit and receive unit 1201.

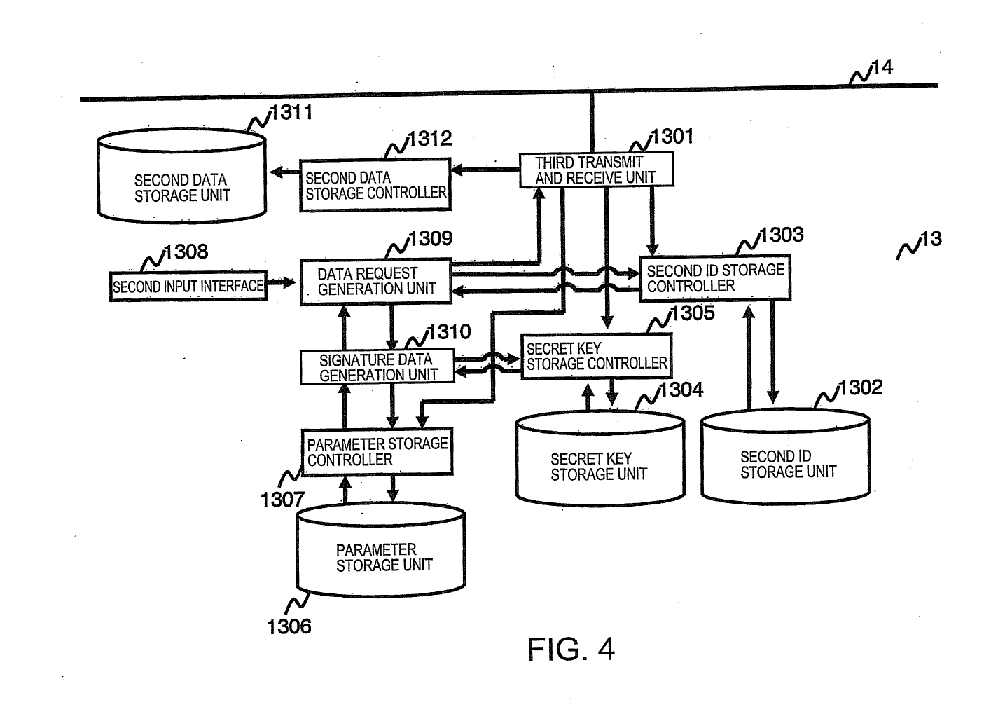

FIG. 4 is a block diagram of the service providing server 13 according to the first embodiment. The service providing server 13 includes a third transmit and receive unit 1301, a second ID storage unit 1302, a second ID storage controller 1303, a secret key storage unit 1304, a secret key storage controller 1305, a parameter storage unit 1306, a parameter storage controller 1307, a second input interface 1308, a data request generation unit 1309, a signature data generation unit 1310, a second data storage unit 1311, and a second data storage controller 1312.

The service providing server 13 performs some service by using measurement data. For example, an infra service such as a power distribution service may be provided. However, the service is not limited to the infra service.

The third transmit and receive unit 1301 transmits data to or receives data from other devices except for the service providing server 13. For example, the third transmit and receive unit 1301 transmits data to or receives data from the user terminal 11 and the data storage device 12.

The third transmit and receive unit 1301 transmits a use application command to the user terminal 11.

The third transmit and receive unit 1301 receives an ID, a secret key d_ID and a public parameter params from the user terminal 11.

The third transmit and receive unit 1301 transmits a data request M, an ID and a signature sig thereof to the data storage device 12. The third transmit and receive unit 1301 receives an error or data from the data storage device 12.

The second ID storage unit 1302 stores an ID transmitted from the user terminal 11.

The second ID storage controller 1303 accepts the ID transmitted from the user terminal 11 via the third transmit and receive unit 1301, and writes the ID into the second ID storage unit 1302. The second ID storage controller 1303 accepts a request of an ID from the data request generation unit 1309, reads the ID from the second ID storage unit 1302, and sends the ID to the data request generation unit 1309.

The secret key storage unit 1304 stores a secret key d_ID received by the third transmit and receive unit 1301 from the user terminal 11.

The secret key storage controller 1305 accepts the secret key d_ID from the third transmit and receive unit 1301, and writes the secret key d_ID into the secret key storage unit 1304.

The secret key storage controller 1305 accepts a request of a secret key d_ID from the signature data generation unit 1310, reads the secret key d_ID from the secret key storage unit 1304, and sends the secret key d_ID to the signature data generation unit 1310.

The parameter storage unit 1306 stores a public parameter params received by the third transmit and receive unit 1301 from the user terminal 11.

The parameter storage controller 1307 accepts the public parameter params from the third transmit and receive unit 1301, and writes it into the parameter storage unit 1306.

The second input interface 1308 may accept a request to generate a data request from a user, and may send the request to the data request generation unit 1309. Furthermore, when a condition is periodically satisfied, a data request generation request unit (not shown in FIG. 4) in the service providing server 13 may send a request to generate a data request to the data request generation unit 1309.

The data request generation unit 1309 accepts the request to generate a data request, and generates a data request M for the data storage device 12 to decide target data.

The data request generation unit 1309 sends the data request M and a request to generate signature data sig for M to the signature data generation unit 1310.

The data request generation unit 1309 accepts the signature data sig generated by the signature data generation unit 1310.

The data request generation unit 1309 accepts a request to acquire an ID from the second input interface 1308, sends the request to the second ID storage controller 1303, and accepts the ID from the second ID storage controller 1303.

Then, the data request generation unit 1309 generates a data request command (M, sig, ID).

The signature data generation unit 1310 accepts a data request M and a request to generate signature data sig from the data request generation unit 1309, and requests the secret key storage controller 1305 to acquire a secret key d_ID.

The signature data generation unit 1310 accepts the secret key d_ID from the secret key storage controller 1305.

The signature data generation unit 1310 generates signature data sig based on the data request M and the secret key d_ID.

The signature data generation unit 1310 sends the signature data M to the data request generation unit 1309.

The second data storage unit 1311 stores data received by the third transmit and receive unit 1301 from the data storage device 12. A purpose to use the data and a method thereof are not explained.

The second data storage controller 1312 accepts data received by the third transmit and receive unit 1301, and writes the data into the second data storage unit 1311.

<Operation>

<(1) System Setup Processing>

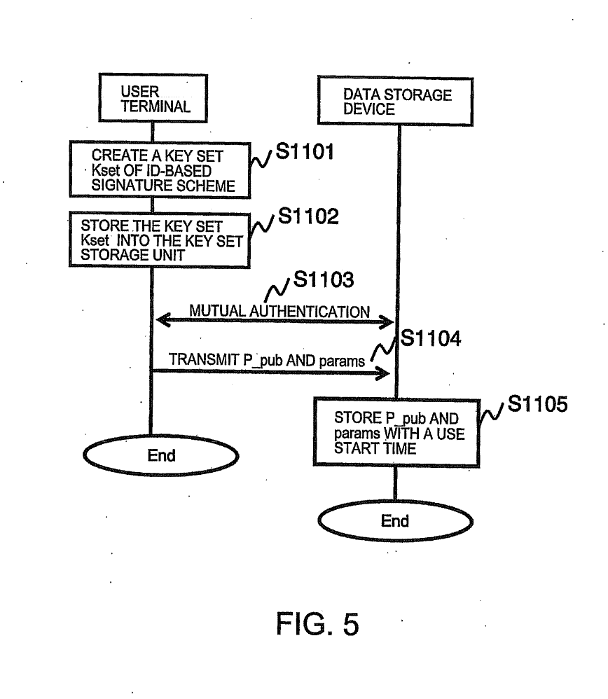

FIG. 5 is a flow chart of setup processing of the access control system 1 according to the first embodiment.

In the user terminal 11, the key set generation unit 1103 accepts a request from the first input interface 1102, and creates a key set Kset=(P_pub, s, params) of ID-based signature scheme (S1101).

In the user terminal 11, the key set storage controller 1104 stores the key set Kset into the key set storage unit 1105 (S1102).

The user terminal 11 executes suitable authentication processing with the data storage device 12 (S1103).

In the user terminal 11, the key set storage controller 1104 sends a public key P_pub and a public parameter params included in the key set Kset to the data storage device 12 via the first transmit and receive unit 1101 (S1104).

In the data storage device 12, the second transmit and receive unit 1201 receives the public key P_pub and the public parameter params (transmitted from the user terminal 11). The public key storage controller 1203 writes them with a use start time (including the date) thereof into the public key storage unit 1202 (S1105).

<(2) Registration Processing of Service Providing>

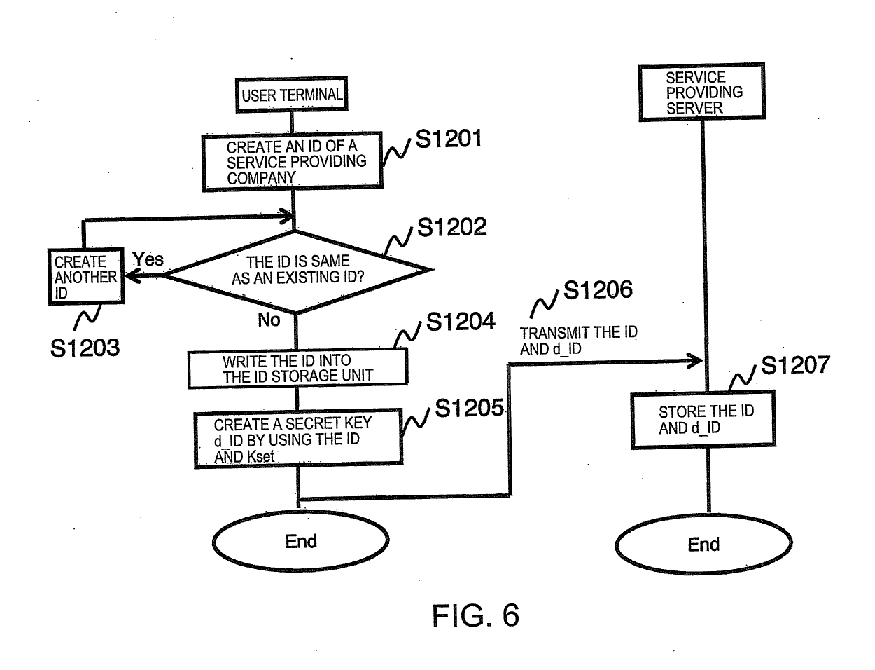

FIG. 6 is a flow chart of registration processing when a user selects a service to be provided.

In the user terminal 11, the ID generation unit 1106 accepts a user's request from the first input interface 1102, and creates information ID including following a, b and c (S1201).

a. an identifier of service providing (such as a character string, a random number, or a combination thereof)

b. an issue date and a validity period of a secret key to be issued

c. a parameter related to the service providing

In the user terminal 11, the ID assignment control unit 1107 confirms whether this ID is same as one of IDs stored in the first ID storage unit 1109 (S1202).

If this ID is same as one of IDs stored, the ID assignment control unit 1107 requests the ID generation unit 1106 to generate a new ID. As a result, overlap of the ID is removed (S1203).

If this ID is not same as each of IDs stored, the ID assignment control unit 1107 writes this ID into the first ID storage unit 1109 via the first ID storage controller 1108 (S1204).

In the user terminal 11, the secret key generation unit 1110 creates a secret key d_ID for the service providing by using the ID and the key set Kset (S1205).

In the user terminal 11, the first transmit and receive unit 1101 transmits the secret key d_ID and the information ID to the service providing server 13 (S1206).

In the service providing server 13, the third transmit and receive unit 1301 receives the secret key d_ID and the information ID. Then, the secret key storage controller 1305 writes the secret key d_ID into the secret key storage unit 1304, and the second ID storage controller 1303 writes the ID into the second ID storage unit 1302 (S1207.

<(3) Data Request/Acquisition Processing of the Service Providing Server 13>

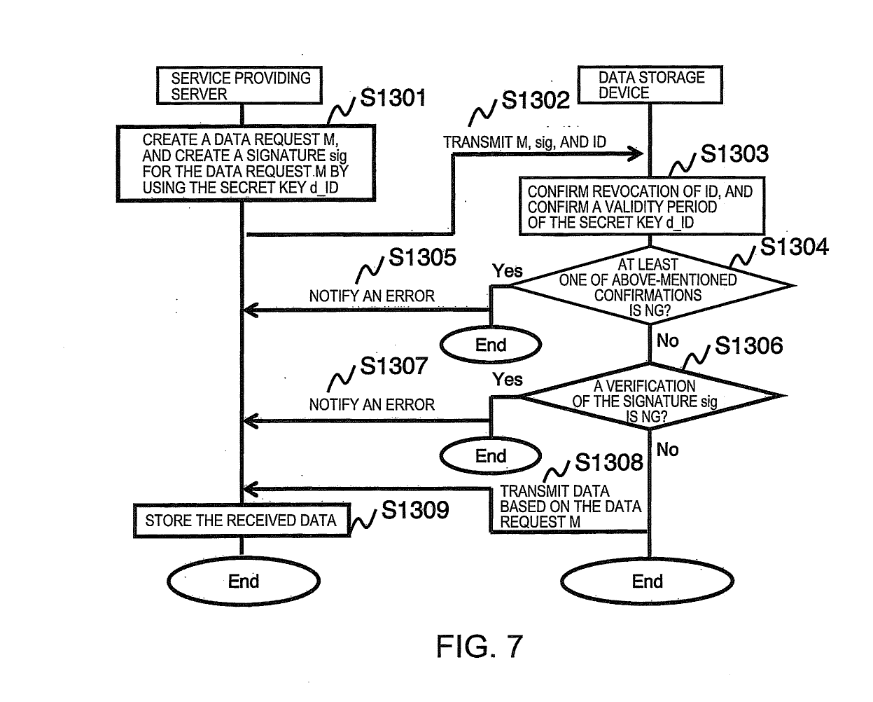

FIG. 7 is a flow chart of processing for the service providing server 13 to request and acquire data.

In the service providing server 13, the second input interface 1308 accepts a user request. The data request generation unit 1309 creates a data request M. Then, the signature data generation unit 1310 creates signature data sig for the data request M by using the secret key d_ID (stored in the secret key storage unit 1304) and the data request M (S1301).

In the service providing server 13, the data request generation unit 1309 transmits a data request command (M, sig, ID) to the data storage device 12 via the third transmit and receive unit 1301 (S1302).

In the data storage device 12, the second transmit and receive unit 1201 receives the data request command. The revocated ID list storage controller 1207 confirms whether an ID included in the data request command is revocated or not (S1303). If the ID is revocated (Yes at S1304), the revocated ID list storage controller 1207 sends an error to the second transmit and receive unit 1201 (S1305). Furthermore, the revocated ID list storage controller 1207 decides whether the present time is within a validity period of the secret key included in the ID (S1303). If the present time is over the validity period (Yes at S1304), the revocated ID list storage unit 1207 sends an error to the second transmit and receive unit 1201 (S1305).

If the ID is valid and the present time is within the validity period of the secret key (No at S1304), the signature verification processing unit 1208 confirms authenticity of the data request M by verifying the signature sig. If authenticity of the data request M is not confirmed (Yes at S1306), the signature verification processing unit 1208 transmits an error to the service providing server 13 via the second transmit and receive unit 1201 (S1307). If authenticity of the data request M is confirmed (No at S1306), the signature verification processing unit 1208 generates a request to transmit (a part of) data stored in the first data storage unit 1204 to the service providing server 13, based on the data request M, and sends the request to the first data storage controller 1205. The first data storage controller 1205 reads data to be transmitted from the first data storage unit 1204, and transmits the data to the service providing server 13 via the second transmit and receive unit 1201 (S1308).

In the service providing server 13, the third transmit and receive unit 1301 receives data transmitted from the data storage device 12. The second data storage controller 1312 writes the data into the second data storage unit 1311 (S1309).

Moreover, when the data storage device 12 stores a plurality of public keys, a suitable public key is selected by checking following items included in the ID transmitted.

1. Whether this ID is included in the revocated ID list or not.

2. Whether the validity period of the secret key has expired or not.

<(4) Update Processing of a Contact for Service Providing>

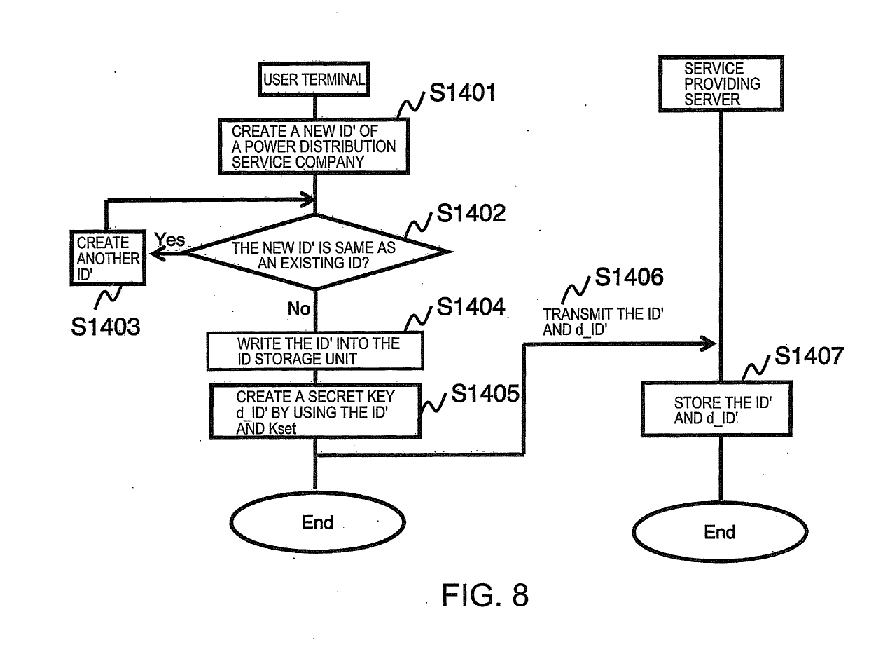

FIG. 8 is a flow chart of update processing of a contact for service providing when a validity period of an ID (issued to the service providing company) is likely to expire.

In the user terminal 11, when the ID generation unit 1106 accepts a request to create a new ID′ for service providing from the first input interface 1102, the ID generation unit 1106 creates the new ID′ including following a, b and c (S1401).

a. an identifier of service providing

b. an issue date and a validity period of a secret key to be issued

c. a parameter related to the service providing

In the user terminal 11, the ID assignment control unit 1107 confirms whether the ID′ is same as one of IDs stored in the first ID storage unit 1109 (S1402).

If the ID′ is same as one of IDs stored, the ID assignment control unit 1107 requests the ID generation unit 1106 to create a new ID′. As a result, overlap of the ID′ is removed (S1403).

If the ID′ is not same as each of IDs stored, the ID assignment control unit 1107 requests the first ID storage controller 1108 to write the ID′ into the first ID storage unit 1109 (S1404).

In the user terminal 11, the secret key generation unit 1110 generates a secret key d_ID′ for the service providing by using the ID′ and the key set Kset (S1405).

In the user terminal 11, the first transmit and receive unit 1101 transmits the secret key d_ID′ and the ID′ to the service providing server 13 (S1406).

In the service providing server 13, the third transmit and receive unit 1301 receives the secret key d_ID′ and the ID′. Then, the secret key storage controller 1305 writes the secret key d_ID′ into the secret key storage unit 1304, and deletes an old d_ID. Furthermore, the second ID storage controller 1303 writes the ID′ into the second ID storage unit 1302, and deletes an old ID (S1407).

<(5) Change Processing of Service Providing>

When the validity period of the secret key of the service providing company expired, processing to change the service providing is same as above-mentioned “(2) Registration processing of service providing”.

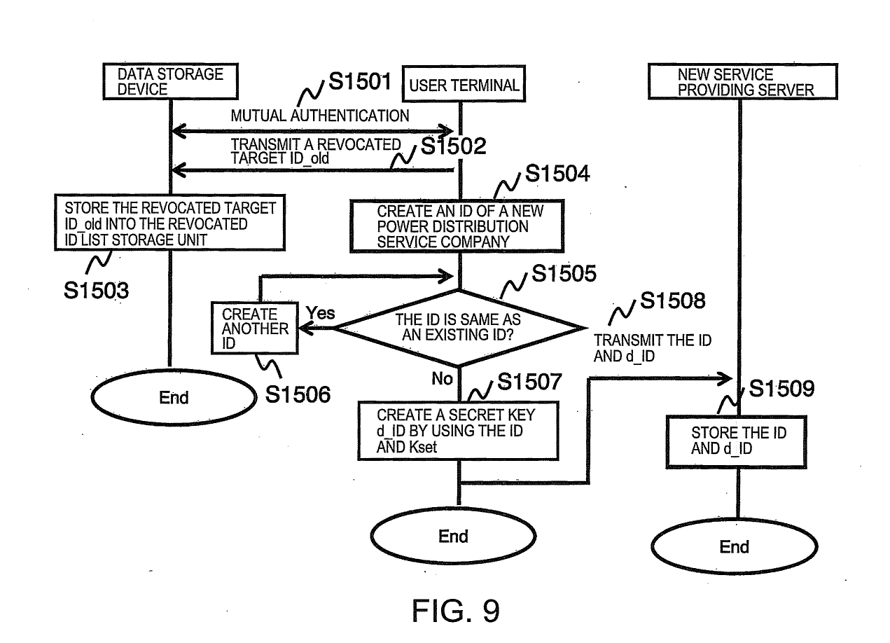

FIG. 9 is a flow chart of processing to change the service providing company before the validity period of the secret key for the service providing company (already contracted) expires. In this case, revocation of the secret key of the service providing company (already contracted) is necessary.

The user terminal 11 performs suitable authentication processing with the data storage device 12 (S1501).

In the user terminal 11, when the ID assignment control unit 1107 accepts a request to revocate an ID of the service providing company (already contracted) from a user via the first input interface 1102, the ID assignment control unit 1107 reads an ID_old as the ID of the service providing company by using the first ID storage controller 1108, and transmits the ID_old to the data storage device 12 via the first transmit and receive unit 1101 (S1502).

In the data storage device 12, the second transmit and receive unit 1201 receives the ID_old, and writes the ID_old into the revocated ID list storage unit 1206 by using the revocated ID list storage controller 1207 (S1503).

After that, between the user terminal 11 and a new service providing server 13, the same processing as “(2) Registration processing of service providing” is performed (S1504˜S1508).

### The Second Embodiment

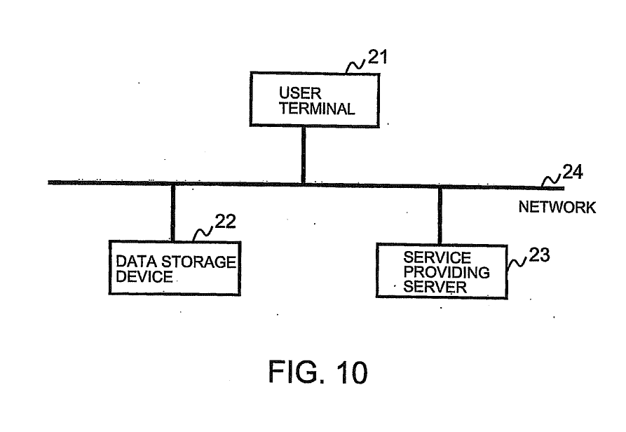

FIG. 10 is a block diagram of an access control system 2 according to the second embodiment. As shown in FIG. 10, in the access control system 2, a user terminal 21, a data storage device 22 and a service providing server 23, are connected via a communication network 24.

Moreover, in order to simplify Figure, as the user terminal 21, the data storage device 22 and the service providing server 23, respective one units are only shown in FIG. 10. However, a plurality of user terminals 21, a plurality of data storage devices 22 and a plurality of service providing servers 23, can be connected with the access control system 2.

The network 24 is, for example, a LAN (Local Area Network), an Intranet, an Ethernet (registered trademark), or the Internet.

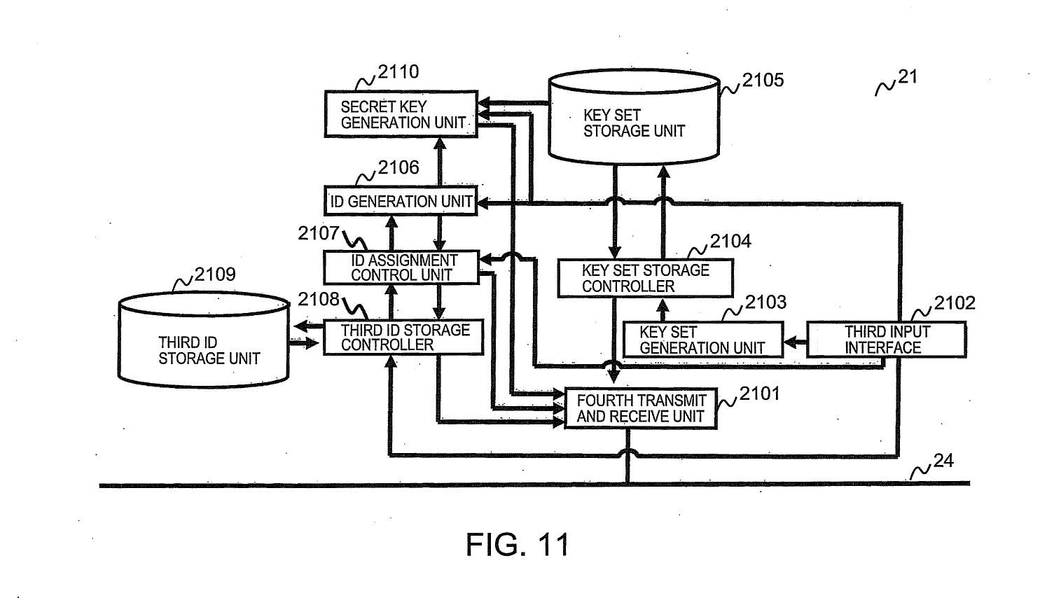

FIG. 11 is a block diagram of the user terminal 21 according to the second embodiment.

The user terminal 21 includes a fourth transmit and receive unit 2101, a third input interface 2102, a key set generation unit 2103, a key set storage controller 2104, a key set storage unit 2105, an ID generation unit 2106, an ID assignment control unit 2107, a third ID storage controller 2108, a third ID storage unit 2109, and a secret key generation unit 2110.

Each unit of the user terminal 21 executes same processing as the corresponding unit of the user terminal 11 of the first embodiment. Accordingly, explanation thereof is omitted.

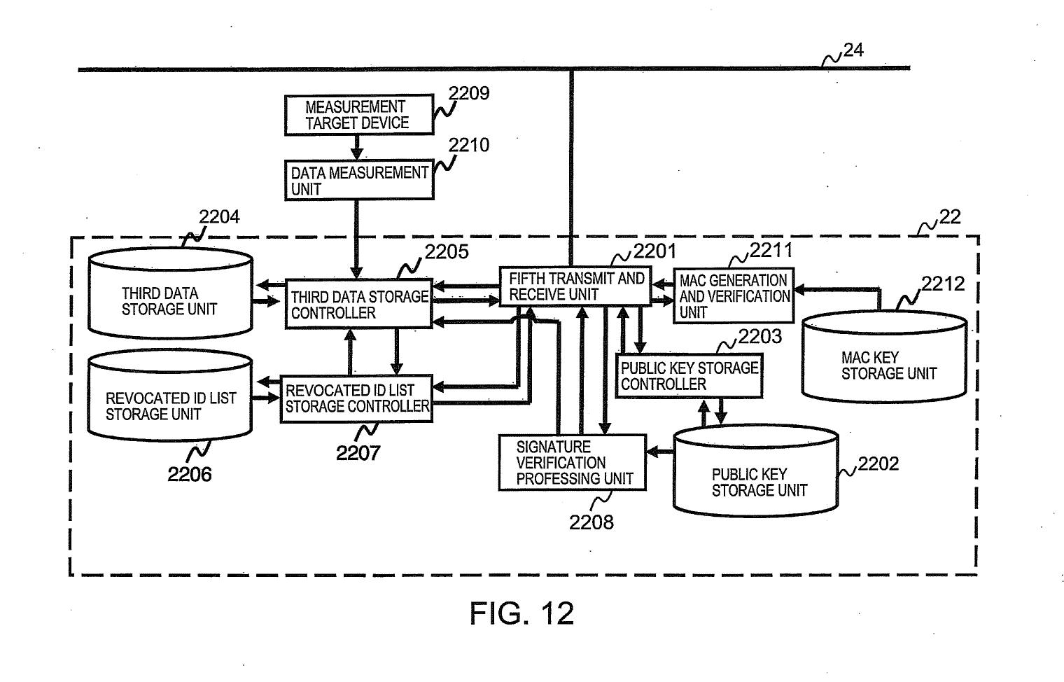

FIG. 12 is a block diagram of the data storage device 22 according to the second embodiment. The data storage device 22 includes a fifth transmit and receive unit 2201, a public key storage unit 2202, a public key storage controller 2203, a third data storage unit 2204, a third data storage controller 2205, a revocated ID list storage unit 2206, a revocated ID list storage controller 2207, a signature verification processing unit 2208, a MAC generation and verification unit 2211, and a MAC key storage unit 2212.

In addition to processing of the second transmit and receive unit 1201 in FIG. 3, the fifth transmit and receive unit 2201 receives a MAC generation request (explained afterwards) and an ID from the user terminal 21, transmits a MAC (Message Authentication Code) to the user terminal 21, and receives a MAC corresponding to the ID from the service providing server 23. The fifth transmit and receive unit 2201 sends the MAC generation request and the ID (received) to the MAC generation and verification unit 2211. When the fifth transmit and receive unit 2211 accepts an error from the public key storage controller 2203, the fifth transmit and receive unit 2211 transmits the error to the user terminal 21.

As to the public key storage unit 2202, the third data storage unit 2204, the third data storage controller 2205, the revocated ID list storage unit 2206, the revocated ID list storage controller 2207 and the signature verification processing unit 2208, respective processing is same as the corresponding unit of the first embodiment. Accordingly, explanation thereof is omitted.

The public key storage controller 2203 confirms whether the public key P_pub (transmitted from the user terminal 21) is same as the latest public key stored in the public key storage unit 2202. Concretely, the public key storage controller 2203 reads the latest public key from the public key storage unit 2202, and confirms whether they are same.

If the public key P_pub is not same as the latest key, the public key storage controller 2203 sends an error to the fifth transmit and receive unit 2201.

When the fifth transmit and receive unit 2201 receives a MAC generation request from the user terminal 21, the MAC generation and verification unit 2211 generates a MAC corresponding to an ID (transmitted with the MAC generation request) by using a MAC key stored in the MAC key storage unit 2212.

The MAC key storage unit 2212 stores the MAC key as a secret key used for generation and verification of MAC. The MAC key is secret information and should be suitably protected in order not to leak out from the data storage device 22. However, the protection method is not explained.

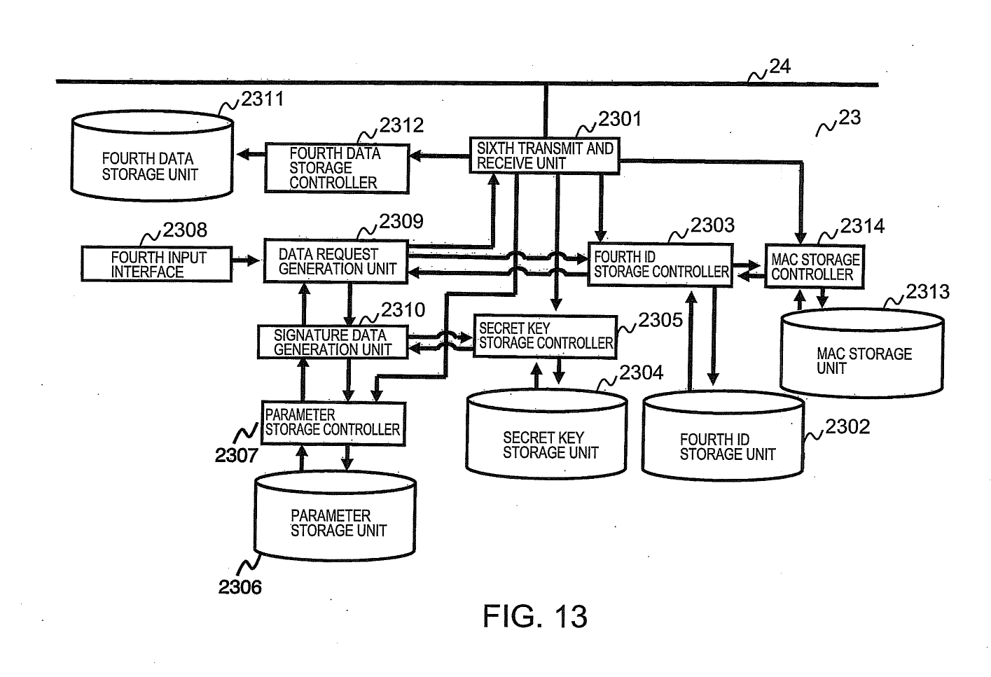

FIG. 13 is a block diagram of the service providing server 23 according to the second embodiment. The service providing server 23 includes a sixth transmit and receive unit 2301, a fourth ID storage unit 2302, a fourth ID storage controller 2303, a secret key storage unit 2304, a secret key storage controller 2305, a parameter storage unit 2306, a parameter storage controller 2307, a fourth input interface 2308, a data request generation unit 2309, a signature data generation unit 2310, a fourth data storage unit 2311, a fourth data storage controller 2312, a MAC storage unit 2313, and a MAC storage controller 2314.

The sixth transmit and receive unit 2301 transmits data to or receives data from other devices except for the service providing server 23. For example, the sixth transmit and receive unit 2301 transmits data to or receives data from the user terminal 21 and the data storage device 22.

The sixth transmit and receive unit 2301 transmits a use application command to the user terminal 21.

The sixth transmit and receive unit 2301 receives an ID, a secret key d_ID and a public parameter params from the user terminal 21.

The sixth transmit and receive unit 2301 transmits a data request M, an ID and a signature sig thereof to the data storage device 22. The sixth transmit and receive unit 2301 receives an error or data from the data storage device 22.

The fourth ID storage unit 2302 stores an ID transmitted from the user terminal 21.

The fourth ID storage controller 2303 accepts the ID transmitted from the user terminal 21 via the sixth transmit and receive unit 2301, and writes the ID into the fourth ID storage unit 2302. The fourth ID storage controller 2303 accepts a request of an ID from the data request generation unit 2309, reads the ID from the fourth ID storage unit 2302, and sends the ID to the data request generation unit 2309.

The secret key storage unit 2304 stores a secret key d_ID received by the sixth transmit and receive unit 2301 from the user terminal 21.

The secret key storage controller 2305 accepts the secret key d_ID from the sixth transmit and receive unit 2301, and writes the secret key d_ID into the secret key storage unit 2304.

The secret key storage controller 2305 accepts a request of a secret key d_ID from the signature data generation unit 2310, reads the secret key d_ID from the secret key storage unit 2304, and sends the secret key d_ID to the signature data generation unit 2310.

The fourth input interface 2308 may accept a request to generate a data request from a user, and may send the request to the data request generation unit 2309. Furthermore, when a condition is periodically satisfied, a data request generation request unit (not shown in FIG. 13) in the service providing server 23 may send a request to generate a data request to the data request generation unit 2309.

The data request generation unit 2309 accepts the request to generate a data request, and generates a data request M for the data storage device 22 to decide target data.

The data request generation unit 2309 sends the data request M and a request to generate signature data sig for M to the signature data generation unit 2310.

The data request generation unit 2309 accepts the signature data sig generated by the signature data generation unit 2310.

The data request generation unit 2309 accepts a request to acquire an ID from the fourth input interface 2308, sends the request to the fourth ID storage controller 2303, and accepts the ID from the fourth ID storage controller 2303.

Then, the data request generation unit 2309 generates a data request command (M, sig, ID).

The signature data generation unit 2310 accepts a data request M and a request to generate signature data sig from the data request generation unit 2309, and requests the secret key storage controller 2305 to acquire a secret key d_ID.

The signature data generation unit 2310 accepts the secret key d_ID from the secret key storage controller 2305.

The signature data generation unit 2310 generates signature data sig based on the data request M and the secret key d_ID.

The signature data generation unit 2310 sends the signature data M to the data request generation unit 2309.

The fourth data storage unit 2311 stores data received by the sixth transmit and receive unit 2301 from the data storage device 22. A purpose to use the data and a method thereof are not explained.

The fourth data storage controller 2312 accepts data received by the sixth transmit and receive unit 2301, and writes the data into the second data storage unit 2311.

The MAC storage unit 2313 stores the MAC.

When the MAC storage controller 2314 accepts the MAC from the sixth transmit and receive unit 2301, the MAC storage controller 2314 writes the MAC into the MAC storage unit 2313. When the MAC storage controller 2314 accepts a request to read a MAC from the fourth ID storage controller 2303, the MAC storage controller 2314 reads the MAC as target data from the MAC storage unit 2313, and sends the MAC to the fourth ID storage controller 2303.

<Operation>

<(1) System Setup Processing>

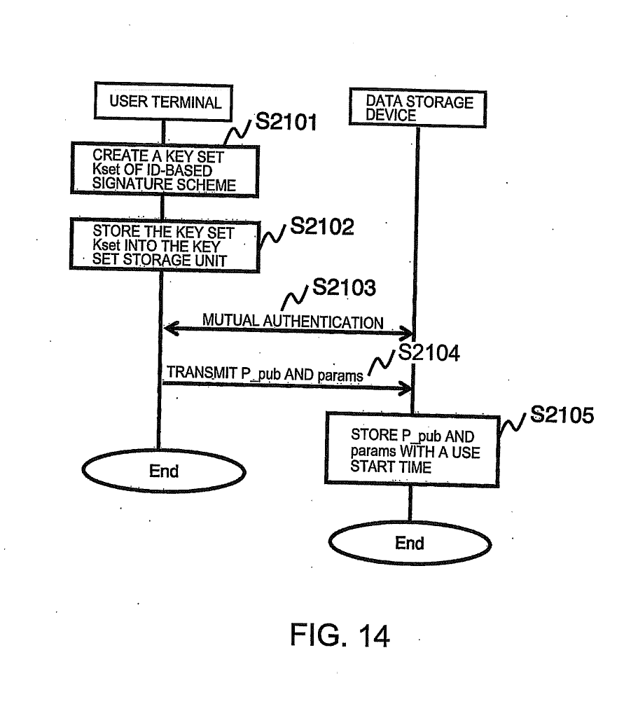

FIG. 14 is a flow chart of setup processing of the access control system 2 according to the second embodiment.

In FIG. 14, processing of S2101˜S2105 is same as that of S1101˜S1105 in FIG. 5. Accordingly, explanation thereof is omitted.

<(2) Registration Processing of Service Providing>

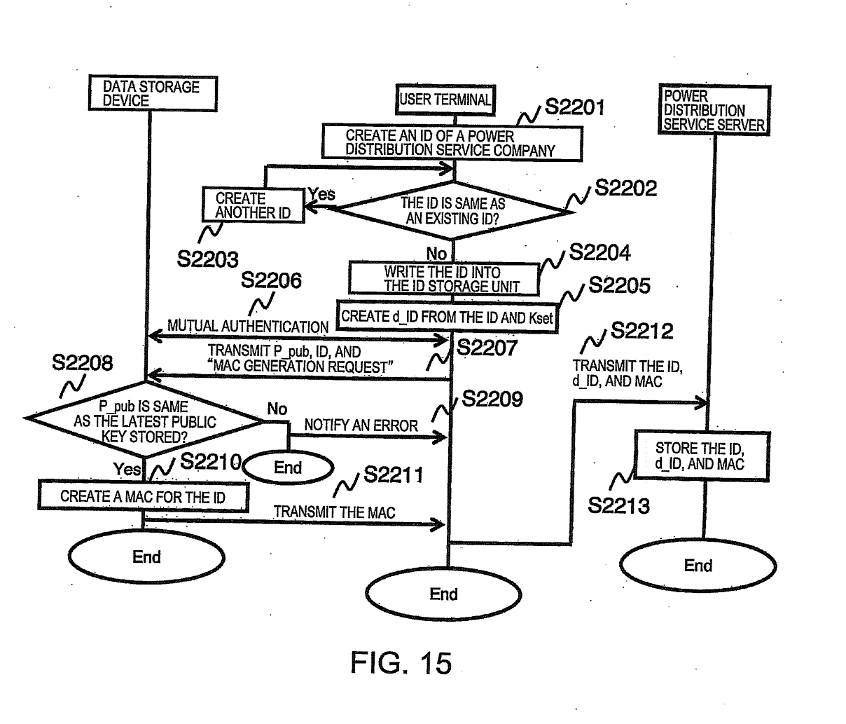

FIG. 15 is a flow chart of registration processing when a user selects a service to be provided.

In the user terminal 21, the ID generation unit 2106 accepts a user's request from the third input interface 2102, and creates information ID including following a, b and c (S2201).

a. an identifier of service providing (such as a character string, a random number, or a combination thereof)

b. an issue date and a validity period of a secret key to be issued

c. a parameter related to the service providing

In the user terminal 21, the ID assignment control unit 2107 confirms whether this ID is same as one of IDs stored in the third ID storage unit 2109 (S2202).

If this ID is same as one of IDs stored, the ID assignment control unit 2107 requests the ID generation unit 2106 to generate a new ID. As a result, overlap of the ID is removed (S2203).

If this ID is not same as each of IDs stored, the ID assignment control unit 2107 writes this ID into the third ID storage unit 2109 via the third ID storage controller 2108 (S2204).

In the user terminal 21, the secret key generation unit 2110 creates a secret key d_ID by using the ID and the key set Kset (S2205).

The user terminal 21 performs suitable authentication processing with the data storage device 22 (S2206).

In the user terminal 21, the fourth transmit and receive unit 2101 transmits a public key d_ID, the ID and a MAC generation request to the data storage device 22 (S2207).

In the data storage device 22, the public key storage controller 2203 confirms whether the public key P_pub is same as the latest public key stored in the public key storage unit 2202 (S2208). If the public key P_pub is not same as the latest public key (No at S2208), the public key storage controller 2203 notifies the user terminal 21 of an error, and processing is completed (S2209).

If the public key P_pub is same as the latest public key (Yes at S2208), the fifth transmit and receive unit 2201 requests the MAC generation and verification unit 2211 to generate a MAC for the ID by using a MAC key, and the MAC generation and verification unit 2211 generates the MAC (S2210). Then, the fifth transmit and receive unit 2201 transmits the MAC to the user terminal 21 (S2211).

The user terminal 21 transmits the secret key d_ID, the ID and the MAC to the service providing server 23 (S2212).

The service providing server 23 receives the secret key d_ID, the ID and the MAC, and respectively stores the secret key d_ID, the ID and the MAC into the secret key storage unit 2304, the fourth ID storage unit 2302 and the MAC storage unit 2313 (S2213).

<(3) Data Request/Acquisition Processing of the Service Providing Server 23>

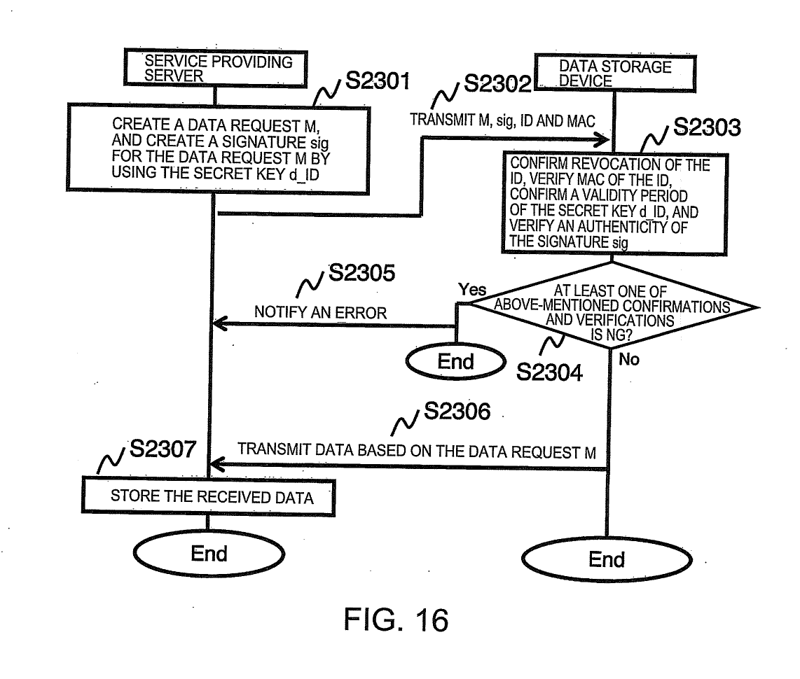

FIG. 16 is a flow chart of processing for the service providing server 23 to request and acquire data.

In the service providing server 23, the fourth input interface 2308 accepts a user request. The data request generation unit 2309 creates a data request M. Then, the signature data generation unit 2310 creates signature data sig for the data request M by using the secret key d_ID (stored in the secret key storage unit 2304) and the data request M (S2301).

The data request generation unit 2309 requests the fourth ID storage controller 2303 to acquire an ID and a MAC. The fourth ID storage controller 2303 reads the ID from the fourth ID storage unit 2302, reads the MAC from the MAC storage unit 2313 via the MAC storage controller 2341, and sends the ID and the MAC to the data request generation unit 2309. Than, the data request generation unit 2309 sends the data request M, the signature data sig, the ID and the MAC to the sixth transmit and receive unit 2301. The sixth transmit and receive unit 2301 transmits a data request command (M, sig, ID, MAC) to the data storage device 22 (S2302).

In the data storage device 22, the fifth transmit and receive unit 2201 receives the data request command. The revocated ID list storage controller 2207 confirms whether an ID included in the data request command is revocated or not (S2303). If the ID is revocated (Yes at S2304), the revocated ID list storage controller 2207 sends an error to the fifth transmit and receive unit 1201 (S2305).

The fifth transmit and receive unit 2211 sends the MAC and the ID included in the data request command to the MAC generation and verification unit 2211. The MAC generation and verification unit 2211 generates a MAC based on the ID, and verifies the ID by comparing the MAC (included in the data request command) with the MAC generated based on the ID (S2303). If authenticity of the ID is incorrect because two MAC are not same (Yes at S2304), the MAC generation and verification unit 2211 sends an error to the fifth transmit and receive unit 2201 (S2305).

Furthermore, the revocated ID list storage controller 2207 decides whether the present time is within a validity period of the secret key included in the ID (S2303). If the present time is over the validity period (Yes at S2304), the revocated ID list storage unit 2207 sends an error to the fifth transmit and receive unit 1201 (S2305).

The signature verification processing unit 2208 confirms authenticity of the data request M by verifying the signature sig (S2303). If authenticity of the data request M is not confirmed (Yes at S2304), the signature verification processing unit 2208 transmits an error to the service providing server 23 via the fifth transmit and receive unit 2201 (S2305). If authenticity of the data request M is confirmed (No at S2304), the signature verification processing unit 2208 generates a request to transmit (a part of) data stored in the third data storage unit 2204 to the service providing server 23, based on the data request M, and sends the request to the third data storage controller 2205. The third data storage controller 2205 reads data to be transmitted from the third data storage unit 2204, and transmits the data to the service providing server 23 via the fifth transmit and receive unit 2201 (S2306).

In the service providing server 23, the sixth transmit and receive unit 2301 receives data transmitted from the data storage device 22. The fourth data storage controller 2312 writes the data into the fourth data storage unit 2311 (S2307).

<(4) Update Processing of a Contact for Service Providing>

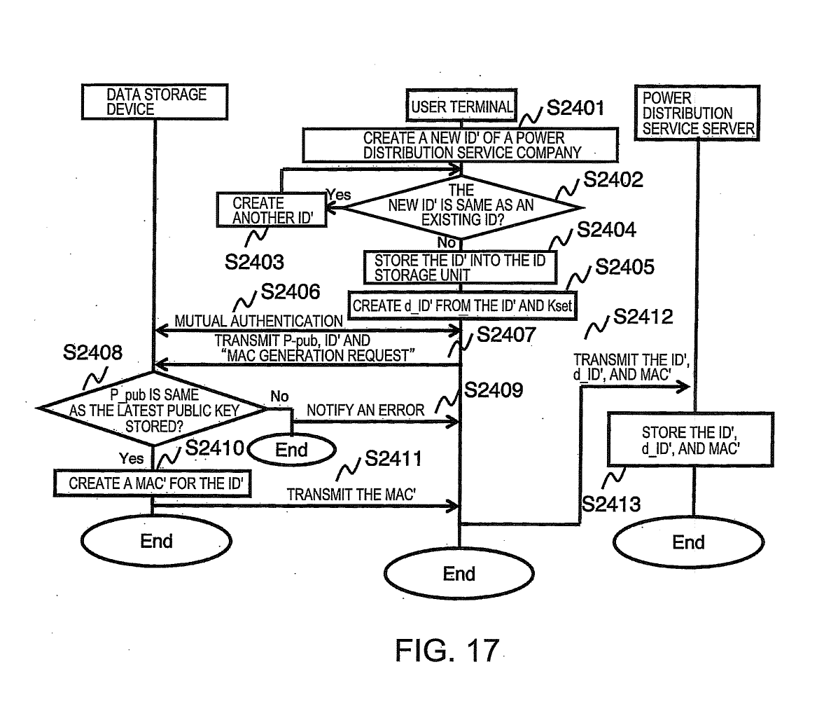

FIG. 17 is a flow chart of update processing of a contact for service providing when a validity period of an ID (issued to the service providing company) is likely to expire.

In the user terminal 21, when the ID generation unit 2106 accepts a request to create a new ID′ for service providing from the third input interface 2102, the ID generation unit 2106 creates information ID′ including following a, b and c (S2401).

a. an identifier of service providing (such as a character string, a random number, or a combination thereof)

b. an issue date and a validity period of a secret key to be issued

c. a parameter related to the service providing

In the user terminal 21, the ID assignment control unit 2107 confirms whether the ID′ is same as one of IDs stored in the third ID storage unit 2109 (S2402).

If the ID′ is same as one of IDs stored, the ID assignment control unit 2107 requests the ID generation unit 2106 to create a new ID′. As a result, overlap of the ID′ is removed (S2403).

If the ID′ is not same as each of IDs stored, the ID assignment control unit 2107 requests the third ID storage controller 2108 to write the ID′ into the third ID storage unit 2109 (S2404).

In the user terminal 21, the secret key generation unit 2110 generates a secret key d_ID′ for the service providing by using the ID′ and the key set Kset (S2405).

The user terminal 21 performs suitable authentication processing with the data storage unit (S2406). In the user terminal 21, the fourth transmit and receive unit 2101 transmits the public key P_pub, the ID′ and a MAC generation request to the data storage device 22 (S2407).

In the data storage device 22, the public key storage controller 2203 confirms whether the public key P_pub is same as the latest public key stored in the public key storage unit 2202 (S2408). If the public key P_pub is not same as the latest public key (No at S2408), the public key storage controller 2203 notifies the user terminal 21 of an error, and processing is completed (S2409).

If the public key P_pub is same as the latest public key (Yes at S2408), the fifth transmit and receive unit 2201 requests the MAC generation and verification unit 2211 to generate a MAC′ for the ID′ by using a MAC key, and the MAC generation and verification unit 2211 generates the MAC′ (S2410). Then, the fifth transmit and receive unit 2201 transmits the MAC′ to the user terminal 21 (S2411).

The user terminal 21 transmits the secret key d_ID′, the ID′ and the MAC′ to the service providing server 23 (S2412).

The service providing server 23 receives the secret key d_ID′, the ID′ and the MAC′, and respectively stores the secret key d_ID′, the ID′ and the MAC′ into the secret key storage unit 2304, the fourth ID storage unit 2302 and the MAC storage unit 2313 (S2413).

Moreover, when the data storage device 22 stores a plurality of public keys, a suitable public key is selected by checking following items included in the ID transmitted.

1. Whether this ID is included in the revocated ID list or not.

2. Whether a validity period of the secret key has expired or not.

3. Whether an issue date of the secret key is prior to a use completion time of the public key (In case of the latest public key, the use completion time is not recorded. Accordingly, this decision result is always true).

<(5) Change Processing of Service Providing>

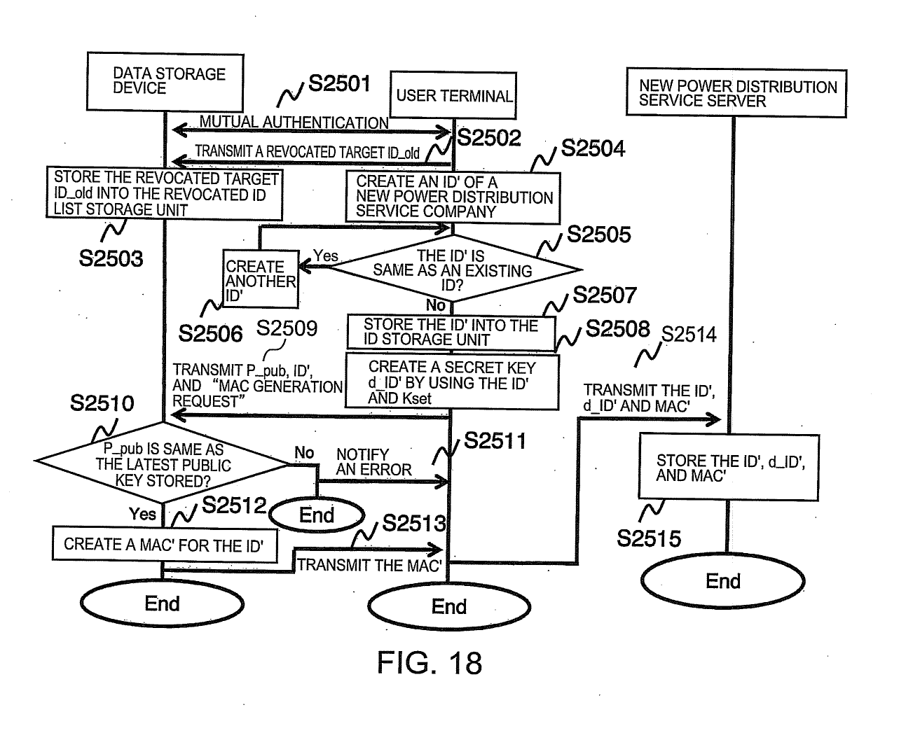

FIG. 18 is a flow chart of processing to change the service providing company before the validity period of the secret key for the service providing company (already contracted) expires. In this case, revocation of the secret key of the service providing company (already contracted) is necessary.

The user terminal 21 performs suitable authentication processing with the data storage device 22 (S2501).

In the user terminal 21, when the ID assignment control unit 2107 accepts a request to change the service providing from a user via the third input interface 2102, the ID assignment control unit 2107 sends a request to read an ID_old as an ID to be revocated to the third ID storage controller 2108. The third ID storage controller 2108 reads the ID_old from the third ID storage unit 2109, and transmits the ID_old to the data storage device 22 via the fourth transmit and receive unit 2101 (S2502).

In the data storage device 22, the fifth transmit and receive unit 2201 sends the ID_old (received) to the revocated ID list controller 2207. The revocated ID list storage controller 2207 writes the ID_old into the revocated ID list storage unit 2206 (S2503).

In the user terminal 21, when the ID generation unit 2106 accepts a user's request from the third input interface 2102, the ID generation unit 2106 creates information ID′ including following a, b and c (S2504).

a. an identifier of service providing (such as a character string, a random number, or a combination thereof)

b. an issue date and a validity period of a secret key to be issued

c. a parameter related to the service providing

In the user terminal 21, the ID assignment control unit 2107 confirms whether the ID′ is same as one of IDs stored in the third ID storage unit 2109 (S2505).

If the ID′ is same as one of IDs stored, the ID assignment control unit 2107 requests the ID generation unit 2106 to create a new ID′. As a result, overlap of the ID′ is removed (S2506).

If the ID′ is not same as each of IDs stored, the ID assignment control unit 2107 requests the third ID storage controller 2108 to write the ID′ into the third ID storage unit 2109 (S2507).

In the user terminal 21, the secret key generation unit 2110 generates a secret key d_ID′ by using the ID′ and the key set Kset (S2508).

In the user terminal 21, the fourth transmit and receive unit 2101 transmits the public key P_pub, the ID′ and a MAC generation request to the data storage device 22 (S2509).

In the data storage device 22, the public key storage controller 2203 confirms whether the public key P_pub is same as the latest public key stored in the public key storage unit 2202 (S2510). If the public key P_pub is not same as the latest public key (No at S2510), the public key storage controller 2203 notifies the user terminal 21 of an error, and processing is completed (S2511).

If the public key P_pub is same as the latest public key (Yes at S2510), the fifth transmit and receive unit 2201 requests the MAC generation and verification unit 2211 to generate a MAC′ for the ID′ by using a MAC key, and the MAC generation and verification unit 2211 generates the MAC′ (S2512). Then, the fifth transmit and receive unit 2201 transmits the MAC′ to the user terminal 21 (S2513).

The user terminal 21 transmits the secret key d_ID′, the ID′ and the MAC′ to the service providing server 23 (S2514).

The service providing server 23 receives the secret key d_ID′ the ID′ and the MAC′, and respectively stores the secret key d_ID′, the ID′ and the MAC′ into the secret key storage unit 2304, the fourth ID storage unit 2302 and the MAC storage unit 2313 (S2515).

<(6) Re-Setup Processing when a Key Set of the User Terminal is Leaked Out (when the User Terminal is Lost)>

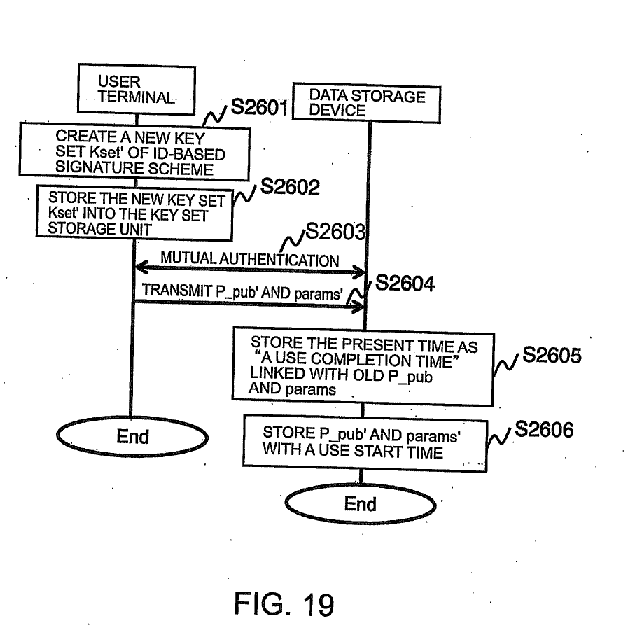

FIG. 19 is a flow chart of re-setup processing when the user terminal is lost, i.e., a key set of the user terminal is leaked out.

In the user terminal 21, when the key set generation unit 2103 accepts a request from the third input interface 2102, the key set generation unit 2103 creates a new key set Kset′=(P_pub′, s′, params′) of ID-based signature scheme (S2601).

In the user terminal 21, the key set storage controller 2104 stores the new key set Kset′ into the key set storage unit 2105 (S2602).

The user terminal 21 performs suitable authentication processing with the data storage device 22 (S2603).

In the user terminal 21, the key set storage controller 2104 transmits a new public key P_pub′ and a new public parameter params′ (included in the new public key Kset′) to the date storage device 22 via the fourth transmit and receive unit 2101 (S2604).

In the data storage device 22, the fifth transmit and receive unit 2201 receives the new public key P_pub′ and the new public parameter params′. The public key storage controller 2203 writes the present time (including the date) as “a use completion time” in correspondence with an old public key P_pub and an old public parameter params, into the public key storage unit 2202 (S2605). Here, in above-mentioned “(2) Registration processing of service providing”, by suitably setting the validity period issued for the service, the old public key and information therewith can be deleted at a suitable time.

In the data storage device 22, the public key storage controller 2203 stores the new public key P_pub′ and the new public parameter params′ with a use start time (including the date) thereof, into the public key storage unit 2202 (S2606).

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An access control system including a user terminal, a data storage unit and a service providing server mutually connected via a network,
the user terminal comprising:
a key set generation unit configured to generate a key set including a public key, a master key, and a public parameter as a parameter opened, by using an ID-based signature scheme based on seed information;
a key set storage to store the key set;
an ID generation unit configured to generate an ID including an identifier of a service, an issue date and a validity period of a secret key corresponding to a service provided by the service providing server;
a first ID storage to store the ID;
a secret key generation unit configured to generate the secret key based on the master key and the ID; and
a first transmit unit configured to transmit the ID and the secret key to the service providing server, and to transmit the public key, the public parameter and a revocated ID to the data storage device;
the service providing server comprising:
a signature data generation unit configured to generate signature data based on the ID and the secret key;
a second ID storage to store the ID;
a secret key storage to store the secret key;
a data request generation unit configured to generate a data request command including a data request, the signature data and the ID; and
a third transmit unit configured to transmit the data request command to the data storage device;
the data storage device comprising:
a first data storage to store measurement data measured from a measurement target device;
a revocated ID list storage to store the revocated ID;
a public key storage to store the public key and the public parameter;
a revocated ID list storage controller configured to decide whether the ID is same as the revocated ID;
a signature verification unit configured to verify the data request based on the signature data, the public key and the public parameter; and
a second transmit unit configured to transmit the measurement data to the service providing server, when the ID is not same as the revocated ID and when authenticity of the data request is verified;
wherein, in the user terminal,
the ID generation unit generates a new ID including an identifier of a new service, an issue date and a validity period of a new secret key corresponding to the new service,
the secret key generation unit generates the new secret key based on the master key and the new ID, and
the first transmit unit transmits the new ID and the new secret key to the service providing server,
wherein, in the service providing server,
the second ID storage stores the new ID, and
the secret key storage stores the new secret key.

2. A user terminal connected with a data storage device and a service providing server via a network, the user terminal comprising:
a key set generation unit configured to generate a key set including a public key, a master key and a public parameter as a parameter opened, by using an ID-based signature scheme based on seed information;
a key set storage to store the key set;
an ID generation unit configured to generate an ID including an identifier of a service, an issue date and a validity period of a secret key corresponding to a service provided by the service providing server;
a first ID storage to store the ID;
a secret key generation unit configured to generate the secret key based on the master key and the ID; and
a first transmit unit configured to transmit the ID and the secret key to the service providing server, and to transmit the public key, the public parameter and a revocated ID to the data storage device; wherein
the ID and the secret key are used for generating signature data by the service providing server,
the signature data, the ID and a data request are included in a data request command by the service providing server and transmitted to the data storage device,
the ID included in the data request command is decided whether to be same as the revocated ID by the data storage device,
the signature data, the public key and the public parameter are used for verifying the data request included in the data request command by the data storage device,
measurement data measured from a measurement target device is stored in the data storage device, and
when the ID is not same as the revocated ID and when authority of the data request is verified, the measurement data is transmitted to the service providing server.

3. An access control system including a user terminal, a data storage unit and a service providing server mutually connected via a network,
the user terminal comprising:
a key set generation unit configured to generate a key set including a public key, a master key and a public parameter as a parameter opened, by using an ID-based signature scheme based on seed information;
a key set storage to store the key set;
an ID generation unit configured to generate an ID including an identifier of a service, an issue date and a validity period of a secret key corresponding to a service provided by the service providing server;
a third ID storage to store the ID;
a secret key generation unit configured to generate the secret key based on the master key and the ID; and
a fourth transmit unit configured to transmit the ID, the public key and a MAC generation request to the data storage device;
the data storage device comprising:
a third data storage to store measurement data measured from a measurement target device;
a public key storage to store the public key and the public parameter;
a public key storage controller configured to decide whether the public key is same as the latest public key;
a MAC generation and verification unit configured to generate a MAC based on the MAC generation request and the ID when the public key is same as the latest public key;
a signature verification unit configured to verify a data request; and
a fifth transmit unit configured to transmit the MAC to the user terminal;
wherein, in the user terminal, the fourth transmit unit transmits the ID, the secret key and the MAC to the service providing server,
the service providing server comprising:
a signature data generation unit configured to generate signature data based on the ID and the secret key;
a fourth ID storage to store the ID;
a secret key storage to store the secret key;
a data request generation unit configured to generate a data request command including the data request, the signature data, the ID and the MAC; and
a sixth transmit unit configured to transmit the data request command to the data storage device;
wherein, in the data storage device,
the MAC generation and verification unit verifies the MAC based on the ID,
the signature verification unit verifies the data request based on the signature data and the public key, and
the fifth transmit unit transmits the measurement data to the service providing server, when authenticity of the MAC is verified and when authenticity of the data request is verified.
